(19) United States
(12) Patent Application Publication
(10) Pub. No.: US 2024/0355112 A1
(43) Pub. Date: Oct. 24, 2024

(54) RECOGNITION APPARATUS, RECOGNITION METHOD, AND NON-TRANSITORY COMPUTER-READABLE MEDIUM

(71) Applicant: CANON KABUSHIKI KAISHA, Tokyo (JP)

(72) Inventor: TOMOAKI NEGISHI, Kanagawa (JP)

(21) Appl. No.: 18/633,641

(22) Filed: Apr. 12, 2024

(30) Foreign Application Priority Data
Apr. 20, 2023 (JP) 2023-069517

(51) Int. Cl. G06V 10/70; G06T 7/00; G06V 10/75

(52) U.S. Cl. CPC G06V 10/87; G06T 7/0002; G06V 10/751; G06T 2207/30184; G06V 2201/10

(57) ABSTRACT

A recognition apparatus is provided. The apparatus generates, through a plurality of sessions of recognition processing on an image of an object of a first time point, a plurality of first recognition results that respectively correspond to the plurality of sessions of recognition processing. The plurality of sessions of recognition processing are for recognizing a recognition target. The apparatus selects a recognition result from among the plurality of first recognition results based on respective changes between a second recognition result and the respective first recognition results. The second recognition result has been obtained through recognition processing on an image of the object of a second time point. The apparatus outputs the selected recognition result.

### BACKGROUND

### Field

The present disclosure relates to a recognition apparatus, a recognition method, and a non-transitory computer-readable medium, and in particular to comparison between results of detection of a recognition target over time.

### Description of the Related Art

A technique to detect a recognition target by applying image processing to an image captured by a camera has been known. For example, a technique to detect a defect from a captured image in an inspection of a structure has been known. Furthermore, a method that uses machine learning to automatically recognize and detect a recognition target through image processing has also been known. Specifically, a model for recognizing a recognition target is generated through training that uses a training data set. Then, a processing apparatus recognizes a recognition target shown in a captured image with use of the obtained model.

Also, there are cases where a time-course change in a recognition target is evaluated based on captured images. For example, in an inspection of a structure, a time-course change in a defect that has occurred in the structure can be evaluated. For example, it is disclosed in Japanese Patent Laid-Open No. 2019-125391 that, together with an inspection image that has been newly obtained with respect to a specific section of a building, a past inspection image of the same section of the same building is displayed for the purpose of comparison. It is also disclosed in Japanese Patent Laid-Open No. 2019-125391 that, in order to facilitate the comparison, image processing is executed to cause the buildings shown in the respective inspection images to match each other in shape and position.

### SUMMARY

According to an embodiment, a recognition apparatus comprises one or more memories storing instructions and one or more processors that execute the instructions to: generate, through a plurality of sessions of recognition processing on an image of an object of a first time point, a plurality of first recognition results that respectively correspond to the plurality of sessions of recognition processing, the plurality of sessions of recognition processing being for recognizing a recognition target; select a recognition result from among the plurality of first recognition results based on respective changes between a second recognition result and the respective first recognition results, the second recognition result having been obtained through recognition processing on an image of the object of a second time point; and output the selected recognition result.

According to still another embodiment, a recognition apparatus comprises one or more memories storing instructions and one or more processors that execute the instructions to: set content of recognition processing, for recognizing a recognition target, on an image of an object of a first time point based on content of recognition processing that has been executed on an image of the object of a second time point to obtain a second recognition result, and on comparison between metadata of the image of the object of the first time point and metadata of the image of the object of the second time point; generate a first recognition result by applying the recognition processing that conforms with the set content on the image of the object of the first time point; and output the first recognition result and the second recognition result.

According to yet another embodiment, a recognition method comprises: generating, through a plurality of sessions of recognition processing on an image of an object of a first time point, a plurality of first recognition results that respectively correspond to the plurality of sessions of recognition processing, the plurality of sessions of recognition processing being for recognizing a recognition target; selecting a recognition result from among the plurality of first recognition results based on respective changes between a second recognition result and the respective first recognition results, the second recognition result having been obtained through recognition processing on an image of the object of a second time point; and outputting the selected recognition result.

According to still yet another embodiment, a non-transitory computer-readable medium stores a program executable by a computer to perform a method comprising: generating, through a plurality of sessions of recognition processing on an image of an object of a first time point, a plurality of first recognition results that respectively correspond to the plurality of sessions of recognition processing, the plurality of sessions of recognition processing being for recognizing a recognition target; selecting a recognition result from among the plurality of first recognition results based on respective changes between a second recognition result and the respective first recognition results, the second recognition result having been obtained through recognition processing on an image of the object of a second time point; and outputting the selected recognition result.

Further features of the present disclosure will become apparent from the following description of exemplary embodiments (with reference to the attached drawings).

### BRIEF DESCRIPTION OF THE DRAWINGS

FIG. 1 is a diagram showing an exemplary hardware configuration of a recognition apparatus according to an embodiment.

FIG. 2 is a diagram showing an exemplary functional configuration of the recognition apparatus according to an embodiment.

FIG. 3 is a diagram showing an example of a processing flow of a recognition processing method according to an embodiment.

FIG. 4 is a diagram showing an example of a UI for designating a recognition target image and a comparison target result.

FIG. 5 is a diagram showing an example of information managed by a result management unit.

FIGS. 6A and 6B are diagrams showing an example of an evaluation value calculation method based on comparison between recognition results.

FIG. 7 is a diagram showing an example of a UI for designating recognition target images and a comparison target result.

FIG. 8 is a diagram showing an example of a processing flow of a recognition processing method according to an embodiment.

FIG. 9 is a diagram showing an example of a display screen showing recognition results.

FIG. 10 is a diagram showing an example of information managed by an image management unit.

FIG. 11 is a diagram showing an example of a UI for designating a recognition target image and comparison target results.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but limitation is not made to an embodiment that requires all such features, and multiple such features may be combined as appropriate. Furthermore, in the attached drawings, the same reference numerals are given to the same or similar configurations, and redundant description thereof is omitted.

Captured images vary also depending on capturing conditions such as a shooting range, a shooting position, weather, and the type of capturing equipment. Therefore, even when a recognition target has not changed, there is a possibility that the results of detection of the recognition target from a plurality of captured images, or the appearances of the recognition target shown in a plurality of captured images, vary. For example, in a case where machine learning is used, the result of detection of a defect depends on a change between captured images. This gives rise to a possibility that the defect detected from a new captured image shrinks compared to the defect detected from a past captured image, even though the defect has a tendency to increase over time. Thus, it has not been easy to compare changes in a recognition target with high accuracy based on a plurality of captured images that were obtained at different time points. This problem still remains in a case where the technique to cause the positions in inspection images to match each other, which is disclosed in Japanese Patent Laid-Open No. 2019-125391, is employed.

An embodiment of the present disclosure provides a technique that makes it possible to select an appropriate recognition result.

A recognition apparatus according to an embodiment detects a recognition target from an image by executing recognition processing with respect to the image. The types of the image and the recognition target are not limited in particular. The following describes an example in which recognition processing is executed with respect to a captured image of a structure such as a bridge and a tunnel. Also, in the following example, a defect such as a crack is detected from an image as a recognition target. In this case, a degree of progression of the crack can be evaluated by analyzing the extension or enlargement of the crack detected from the structure with the passage of time.

Meanwhile, an image may be a captured image of a human body or an affected part thereof (that is, a medical image). Also, a recognition target may be a lesion such as cancer. A progression of a medical condition can be recognized by detecting a lesion from each of medical images of different time points. As another example, an image may be an image of a geographical region, such as a satellite image. Furthermore, a recognition target may be a terrain. Erosion of the terrain can be recognized by recognizing the terrain in each of images of different time points. As such, the recognition apparatus according to the present embodiment can recognize a recognition target that changes with the passage of time.

### First Embodiment

A recognition apparatus according to an embodiment described below generates a plurality of recognition results by applying recognition processing to a recognition target image. Then, a recognition result is selected from among the plurality of recognition results based on comparison with a recognition result (a comparison target result) that has already been obtained. In an embodiment, the recognition result to be selected is searched for so that the comparison target result and the selected recognition result indicate an appropriate change over time (or time-course change). Then, the selected recognition result is output. The time-course change in the recognition target can be checked with high accuracy by referring to the output recognition result. According to the present embodiment, a recognition result that is suited for checking a time-course change in a recognition target can be obtained efficiently.

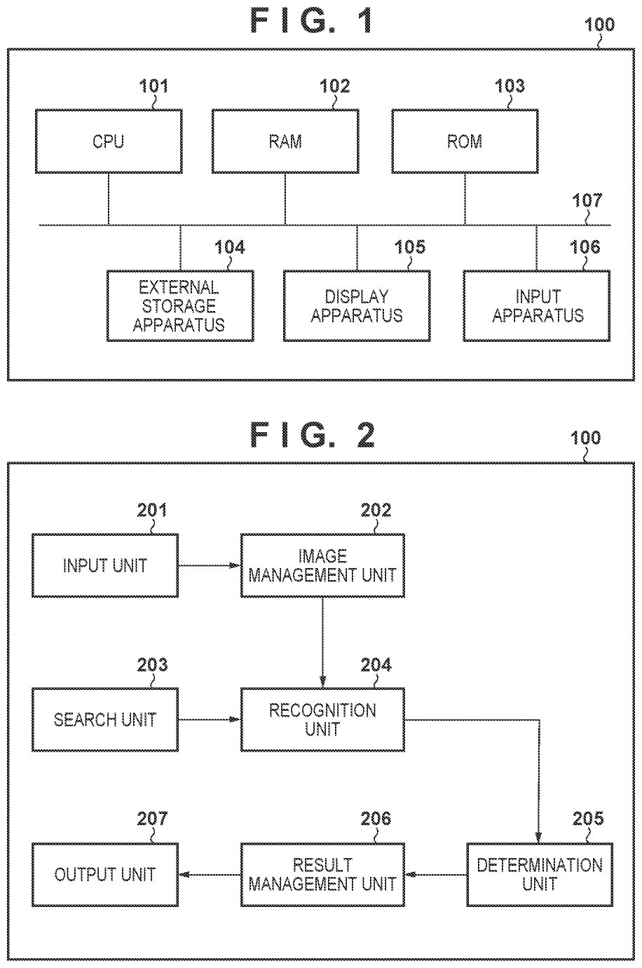

The recognition apparatus according to the present embodiment can be realized by a computer that includes a processor and a memory. An exemplary hardware configuration of a recognition apparatus according to an embodiment will be described with reference to FIG. 1. As shown in FIG. 1, a recognition apparatus 100 includes a CPU 101, a ROM 102, a RAM 103, an external storage apparatus 104, a display apparatus 105, and an input apparatus 106.

The CPU 101 is a central processing unit. The CPU 101 controls the operations of each constituent element connected to a system bus 107. The read-only memory (ROM) 102 is a program memory. The ROM 102 can store a program for causing the CPU 101 to execute each type of processing of the recognition apparatus 100, which will be described later. The random access memory (RAM) 103 is used as a main memory for the CPU 101 or a temporary storage area therefor, such as a working area. The external storage apparatus 104 is an apparatus that stores data. The external storage apparatus 104 includes an interface that accepts an I/O command for reading and writing data. The external storage apparatus 104 can store a computer program or data for causing the CPU 101 to execute each type of processing of the recognition apparatus 100, which will be described later. The external storage apparatus 104 may be a hard disk drive (HDD), a solid-state drive (SSD), an optical disc drive, a semiconductor storage apparatus, or another storage apparatus.

In this way, the functions of each unit shown in FIG. 2 and the like, which will be described later, can be realized by a processor like the CPU 101 executing programs stored in memories such as the ROM 102, the RAM 103, and the external storage apparatus 104.

The display apparatus 105 outputs information to a display screen. The display apparatus 105 is, for example, a CRT display, a liquid crystal display, or the like. The input apparatus 106 accepts inputs or various types of operations from a user. The input apparatus 106 is, for example, a keyboard, a mouse, a touch panel, or the like.

FIG. 2 shows an exemplary functional configuration of the recognition apparatus 100. Although the functions of the recognition apparatus 100 shown in FIG. 2 can be realized by a computer as described above, a part or all of the functions of the recognition apparatus 100 may be realized by dedicated hardware. Furthermore, a recognition apparatus according to an embodiment of the present disclosure may be composed of, for example, a plurality of information processing apparatuses that are connected via a network.

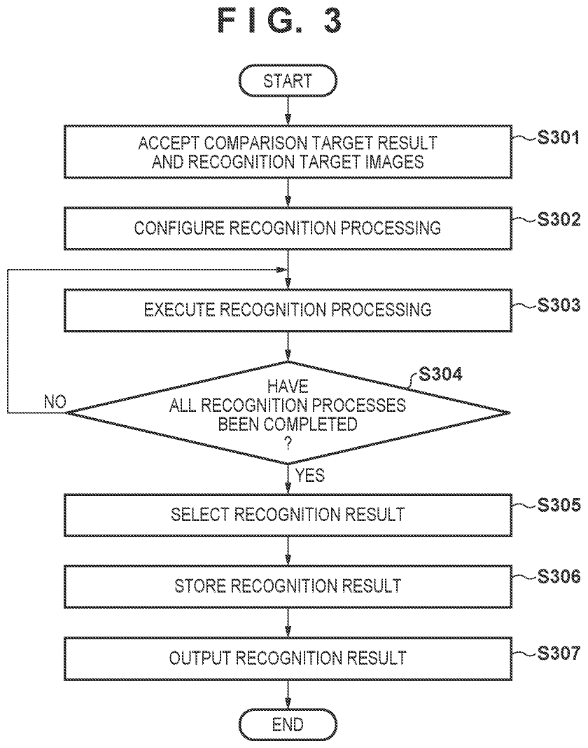

As shown in FIG. 2, the recognition apparatus 100 includes an input unit 201, an image management unit 202, a search unit 203, a recognition unit 204, a determination unit 205, a result management unit 206, and an output unit 207. The recognition apparatus 100 accepts such inputs as an image of a structure, a model used in recognition processing, and a parameter of the recognition processing. Also, it can execute the recognition processing in accordance with a recognition processing flow shown in FIG. 3.

The input unit 201 obtains a recognition target image (a first image). The recognition target image is an image of an object at a first time point. As stated earlier, in the present embodiment, the object is a structure. The recognition target image is used to check a time-course change in a recognition target (e.g., a defect) that has occurred in the object. In the following example, the recognition target image is an image of a wall surface of a structure.

In the present embodiment, the input unit 201 further obtains a comparison target result (a second recognition result). The comparison target result is a recognition result obtained through the recognition processing on an image (a second image) different from the recognition target image. This image different from the recognition target image is an image of the same object as the recognition target image at a second time point different from the first time point. The comparison target result is compared with a recognition result obtained through the recognition processing on the recognition target image in order to check a time-course change in the recognition target (e.g., defect) that has occurred in the object. In the following example, the comparison target result is the result of detection of the defect obtained through the recognition processing on the image of the wall surface of the structure.

The image management unit 202 manages the recognition target image obtained by the input unit 201. The image management unit 202 can manage a plurality of images of the object of different time points (e.g., the recognition target image and the second image).

The search unit 203 configures a setting for the recognition processing executed by the recognition unit 204. In the present embodiment, the recognition unit 204 executes the recognition processing with respect to the recognition target image. Therefore, the search unit 203 provides the recognition unit 204 with the setting for the recognition processing. The setting for the recognition processing can include a designation of a model to be used in the recognition processing, and a setting for the parameter of the recognition processing.

The type of the parameter of the recognition processing is not limited in particular. Examples of the parameter that can be set include a “detection amount” parameter, a “noise removal” parameter, and a “detection width” parameter. The “detection amount” parameter is a parameter that designates the ease of detection of the recognition target. For example, the “detection amount” parameter can indicate a threshold related to the size of the recognition target. More specifically, the “detection amount” parameter can be used to exclude a recognition target smaller than the designated size from the recognition result. For example, in a case where the recognition target is a crack, the “detection amount” parameter that indicates a lower limit of the width of the detected crack can be used. More specifically, the “detection width” parameter can be used to exclude a crack of a width equal to or smaller than the parameter value from the recognition result among the cracks detected by the recognition unit 204. Furthermore, the “noise removal” parameter is a parameter that designates the intensity of noise removal processing. The “noise removal” parameter can indicate a threshold. More specifically, the “noise removal” parameter can be used to exclude a crack of a length equal to or smaller than the designated value from the recognition result so as to suppress erroneous detection of noise appearing in the recognition target image as a crack. Other examples of the parameter that can be set include parameters that designate the type and intensity of image processing that is executed with respect to the recognition target image before the execution of the recognition processing.

In the present embodiment, the recognition unit 204 executes a plurality of sessions of recognition processing with respect to the recognition target image. Therefore, the search unit 203 provides the recognition unit 204 with settings that respectively correspond to the plurality of sessions of recognition processing. For this reason, the search unit 203 can determine search ranges for the model and parameter. Also, the search unit 203 can configure the settings for the plurality of sessions of recognition processing so that each session of recognition processing is executed in accordance with the model and parameter included in the search ranges. For example, the search unit 203 can determine the model and parameter to be used in each session of recognition processing based on a predetermined search method. The search method is not limited in particular. For example, an exhaustive search, a grid search, a random search, Bayesian optimization, or the like can be used as the search method. Note that in the present embodiment, the search ranges are set in advance. Also, one of the model and the parameter may be fixed. For example, the model or the parameter that conforms with the setting for recognition processing that has been executed in the past or the initial setting may be used in a fixed manner. Then, a search may be performed with respect to the other of the model and the parameter.

The recognition unit 204 applies the recognition processing to the recognition target image. In the present embodiment, the recognition unit 204 executes a plurality of sessions of recognition processing with respect to the image of the object at the first time point in order to recognize the recognition target. Consequently, the recognition unit 204 generates a plurality of recognition results (first recognition results) that respectively correspond to the plurality of sessions of recognition processing. As stated earlier, the search unit 203 configures a setting for each of the plurality of sessions of recognition processing. The recognition unit 204 can generate the plurality of first recognition results by applying each of the plurality of sessions of recognition processing, which are different from one another, to the same recognition target image.

The determination unit 205 selects a recognition result from among the plurality of recognition results obtained by the recognition unit 204. The determination unit 205 can select a recognition result from among the plurality of recognition results generated by the recognition unit 204 based on the changes between the comparison target result and the first recognition results.

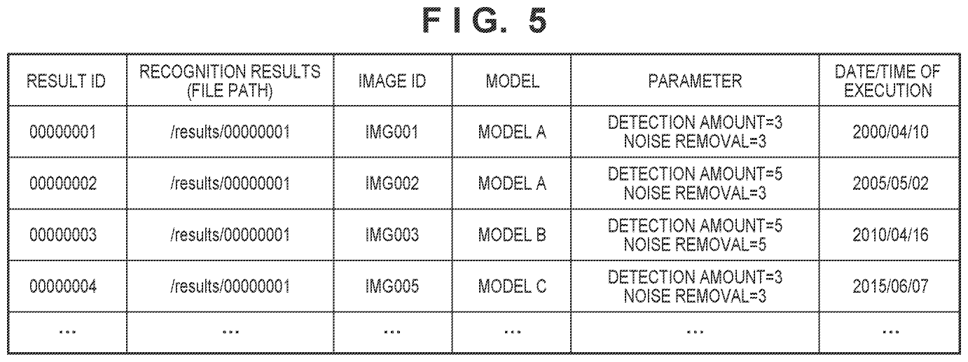

The result management unit 206 can manage the plurality of recognition results obtained by the recognition apparatus 100. In the present embodiment, the result management unit 206 manages recognition results selected by the determination unit 205. As shown in FIG. 5, the result management unit 206 can manage a recognition result in association with a result ID. Also, the result management unit 206 can manage an image ID indicating the recognition target image that was the target of the recognition processing in association with a result ID. Furthermore, the result management unit 206 can manage information indicating the content of the recognition processing in association with a result ID. Examples of the information indicating the content of the recognition processing include information that specifies a model used in the recognition processing, and information indicating the parameter of the recognition processing. In addition, the result management unit 206 can manage other information related to the recognition processing or the recognition target image, such as the date/time of execution of the recognition processing, the name of the object that is the recognition target (e.g., the name of the structure), and the name of a user who has executed the recognition processing, in association with a result ID.

The output unit 207 outputs the recognition result selected by the determination unit 205. The output unit 207 may, for example, output both of the recognition result selected by the determination unit 205 and the comparison target result. The output unit 207 may output a screen that shows recognition results and comparison target results chronologically. The user can check a time-course change in the recognition target by comparing two results. Also, the output unit 207 may output information indicating the setting for the recognition processing that has been used to obtain the recognition result. The output unit 207 may output such a recognition result to an external display apparatus via a network.

FIG. 3 is a flowchart showing a recognition processing flow according to the present embodiment. In the present embodiment, the recognition processing for comparison over time between recognition results is executed.

In step S301, the input unit 201 accepts inputs of recognition target image and a comparison target result. The input unit 201 can obtain the recognition target image and the comparison target result from the outside. Meanwhile, in the present embodiment, the comparison target result is stored in the result management unit 206.

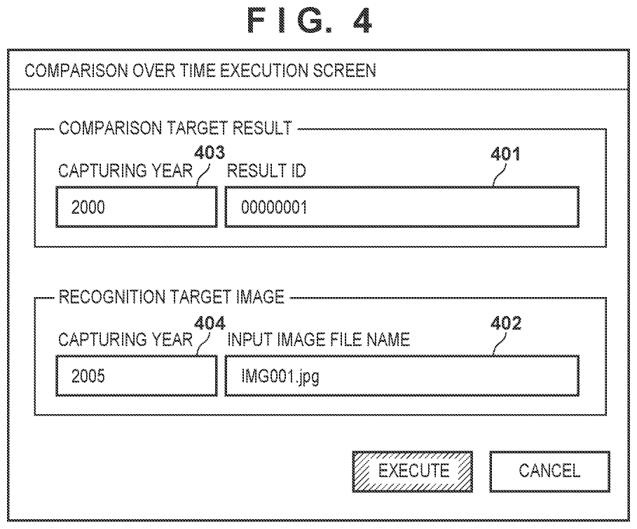

FIG. 4 shows an example of a UI displayed on a screen in the present embodiment. The UI shown in FIG. 4 includes an input area for designating a comparison target result. In the present example, a result ID 401 indicating a recognition result that is selected as the comparison target result is designated. A result ID is a unique value that is given to manage a recognition result obtained through later-described processing. Also, the UI shown in FIG. 4 includes an input area for designating a recognition target image. In the present example, a file name 402 of an image that is selected as the recognition target image is designated.

The input unit 201 obtains the recognition target image that has been designated by the user via the UI from a storage medium or via a network, and stores the recognition target image into the image management unit 202. Note that an image that has already been stored in the image management unit 202 may be designated by the user as the recognition target image. Also, the input unit 201 obtains the comparison target result that has been designated by the user via the UI from the result management unit 206, and supplies the comparison target result to the determination unit 205. The input unit 201 can obtain the comparison target result associated with the designated result ID from the result management unit 206. Note that the user may input a comparison target result owned by the user to the input unit 201. For example, the input unit 201 can obtain a comparison target result that has been uploaded by the user via a network.

As shown in FIG. 4, a capturing year 403 of the image of the structure corresponding to the comparison target result may be designated via the UI. Also, a capturing year 404 of the recognition target image may be designated. The recognition unit 204 can display the recognition target image and the comparison target image in an aligned manner in accordance with these capturing years. Furthermore, the result management unit 206 can manage a recognition result obtained from the recognition target image in association with the capturing year 404. Note that the capturing year 403 related to the comparison target result may be managed by the result management unit 206 together with the comparison target result. In this case, the input unit 201 can automatically set the capturing year 403 corresponding to the comparison target result. In addition, the input unit 201 may automatically set the capturing year 404 of the recognition target image based on the capturing date/time indicated by metadata of the recognition target image.

In step S302, the search unit 203 configures settings for the plurality of sessions of recognition processing as stated earlier. The search unit 203 can determine a model and a parameter to be used for each session of recognition processing in accordance with the search ranges as stated earlier.

In step S303, the recognition unit 204 executes the recognition processing with respect to the recognition target image input in step S301 in accordance with one of the settings for the recognition processing obtained in step S302. Consequently, the recognition unit 204 generates a recognition result. In the present example, the recognition unit 204 executes the recognition processing using a specific model and parameter corresponding to the setting for the recognition processing. In this way, a defect in the structure, such as a crack, is detected from the recognition target image, which is an image of the structure. The form of the recognition result is not limited in particular. For example, in a case where a defect is detected from an image of the structure, the recognition result generated by the recognition unit 204 may be the recognition target image on which a marker indicating the position of the defect is superimposed. Also, the recognition result generated by the recognition unit 204 may be vector data indicating the position and shape of the crack. Note that, as stated earlier, the type of the recognition processing is not limited to recognition of a defect. Therefore, a variety of forms of recognition results are possible.

In step S304, the recognition unit 204 determines whether to continue the recognition processing. The recognition unit 204 can continue the recognition processing until the recognition processing is completed after using all of the settings for the recognition processing generated by the search unit 203. Consequently, the recognition unit 204 can generate recognition results that respectively correspond to the settings for the recognition processing. In a case where the recognition processing is to be continued, processing returns to step S303, and the recognition processing is executed using another setting for the recognition processing that has been generated by the search unit 203 in step S302. In a case where the recognition processing is to be ended, processing proceeds to step S305.

In step S305, the determination unit 205 selects a recognition result from among the recognition results generated in step S303. In the present embodiment, the determination unit 205 selects one recognition result. A detailed selection method will be described later.

In step S306, the result management unit 206 stores the recognition result selected in step S305. Note that the result management unit 206 may store the plurality of recognition results that have been generated respectively through the plurality of sessions of recognition processing by the recognition unit 204 in step S303. In this case, in association with the recognition result selected in step S305, the result management unit 206 may manage information indicating that the selection has been made in step S305.

In step S307, the output unit 207 outputs the recognition result selected in step S305. Also, the output unit 207 can output information indicating the model and parameter used in the recognition processing. Furthermore, the output unit 207 can output the comparison target result as stated earlier. These pieces of information may be presented to the user via the screen.

### [Method of Calculating Evaluation Value]

In the present embodiment, in order to select one recognition result from among the plurality of recognition results, the determination unit 205 refers to changes between the comparison target result and the recognition results. Specifically, a recognition result is selected based on the appropriateness of time-course changes indicated by the comparison target result and the recognition results. For example, the determination unit 205 can select a recognition result so that the change from a past recognition result to the recognition result selected by the determination unit 205 is appropriate.

Here, appropriateness denotes plausibility of a recognition target (e.g., a defect) detected from a plurality of images of the same object that were captured during different periods of time, or naturalness thereof when a change with the passage of time is taken into consideration. For example, a crack that occurs in a structure may extend with the passage of time, but does not normally shorten. Similarly, under normal conditions, a defect that occurs in a structure does not shorten, shrink, or diminish compared to the past. Thus, in a case where a defect that has occurred in a structure has not shortened, shrunk, or diminished compared to the past when a comparison target image and a recognition result have been compared, it means that the appropriateness is high. Furthermore, also in a case where a defect that has occurred in a structure has not excessively enlarged compared to the past when a comparison target image and a recognition result have been compared, it means that the appropriateness is high. The case where the defect has not excessively enlarged denotes, for example, a case where the enlargement of the defect is too much in view of the passage of time, or a case where the enlargement of the defect is too much despite the absence of an event such as a disaster.

For example, the determination unit 205 can determine a change between a feature related to a recognition target indicated by a recognition result and a feature related to the recognition target indicated by a comparison target result. The feature related to the recognition target is, for example, information indicating the position, size, likelihood, or another attribute of the detected recognition target. The feature related to the recognition target can specifically be the size of the defect or the length of the crack. Then, the determination unit 205 can determine the appropriateness of the time-course change based on matching between the determined change and a standard. In this way, the determination unit 205 can select a recognition result based on matching between the determined change and the standard.

In the present embodiment, the determination unit 205 obtains a difference between a recognition result A (e.g., a comparison target result) and a recognition result B (e.g., a recognition result obtained in step S303). Then, the determination unit 205 calculates an evaluation value indicating the appropriateness of a time-course change based on this difference. For example, in a case where the recognition unit 204 outputs an image showing the position of the defect as a recognition result, the determination unit 205 can calculate an evaluation value based on a difference between two images. That is to say, one image includes a predetermined number of pixels. Also, each pixel indicates the likelihood of existence of the defect in the pixel. Here, regarding a time-course change, an increase in a pixel density with the passage of time is deemed appropriate. In view of this, the appropriateness can be estimated based on the amount of decrease in density between corresponding pixels in two images to be compared. For example, the evaluation value indicating the appropriateness may be a sum total of the amounts of decrease in density corresponding to the respective pixels, as follows.

$$S = 1 - \frac{{\sum }_{i = 0}^{n} \vert min \{ {b}_{i} - {a}_{i} , 0 \} \vert}{i} \qquad ( 1 )$$

In expression (1), A (a₀, a₁, . . . , aₙ) denotes the densities of the respective pixels in the recognition result A. Also, B (b₀, b₁, . . . , bₙ) denotes the densities of the respective pixels in the recognition result B. The density of each pixel is denoted by 0 to 1. Furthermore, the recognition result B is a recognition result corresponding to an image that was captured on a newer date/time, whereas the recognition result A is a recognition result corresponding to an image that was captured on an older date/time. Here, according to expression (1), the amount by which the defect has diminished with the passage of time can be estimated as the evaluation value. In a case where the amount by which the defect has diminished is small and the evaluation value is large, it is considered that the appropriateness of the time-course change is high. On the other hand, in a case where the amount by which the defect has diminished is large and the evaluation value is small, it is considered that the appropriateness of the time-course change is low.

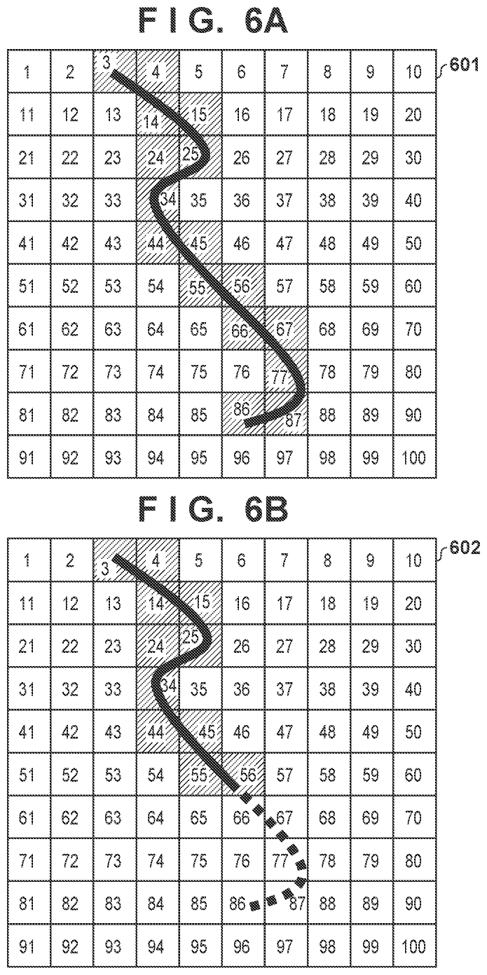

FIG. 6A shows a recognition result 601 as an example of the recognition result A. Also, FIG. 6B shows a recognition result 602 as an example of the recognition result B. In the recognition results 601 and 602, a solid line represents the detected crack, and tinted cells represent pixels with a density of 0 or more. A dotted line shown in FIG. 6B indicates the difference between the cracks in the recognition result 601 and the recognition result 602. The difference between the two recognition results exists in pixels 66, 67, 77, 86, and 87. In this way, the crack shown in the recognition result 602 is shorter than the crack shown in the recognition result 601. That is to say, the amount of the defect in the recognition result 602, which corresponds to the image that was captured on a newer date/time, has diminished compared to that in the recognition result 601. Therefore, it is considered that the appropriateness of the change between the cracks shown in the recognition results 601 and 602 is low. In this case, as the densities decrease in the pixels 66, 67, 77, 86, and 87, a low evaluation value based on the decrease in these densities is calculated in accordance with expression (1). In this way, in a case where two recognition results are compared, a change that is considered to have low appropriateness (e.g., the crack has disappeared, decreased in length, decreased in width, or the like) is detected as the amount by which the defect has diminished.

As described above, the determination unit 205 can determine a change from a first recognition result obtained from a first image of a first time point to a second recognition result obtained from a second image of a second time point, which succeeds the first time point. In an embodiment, appropriateness is determined based on which one of the feature related to the recognition target indicated by the first recognition result and the feature related to the recognition target indicated by the second recognition result is large. In this way, a recognition result can be selected based on matching between the determined change and the standard (in the above-described example, the fact that the crack does not become short). For example, it is determined that appropriateness is higher in a case where the feature related to the recognition target (e.g., the length of the crack) indicated by the second recognition result is larger than the feature related to the recognition target indicated by the first recognition result.

According to the above-described method, an evaluation value is calculated so that it indicates low appropriateness in a case where a defect such as a crack has diminished with the passage of time. Meanwhile, an evaluation value may be calculated so that it indicates low appropriateness in a case where the defect has excessively enlarged. Furthermore, an evaluation value may be calculated in accordance with both of these standards.

An excessive enlargement of a defect can occur due to, for example, erroneous detection and the like. In this case, appropriateness can be estimated based on the amount of increase in density between corresponding pixels in two images to be compared. For example, a sum total of the amounts of increase in density corresponding to the respective pixels can be calculated in accordance with expression (2).

$$S = \frac{{\sum }_{i = 0}^{n} \vert min \{ {b}_{i} - {a}_{i} , 0 \} \vert}{i} \qquad ( 2 )$$

Then, in a case where the calculated sum total of the amounts of increase is larger than a threshold, it can be determined that there is a possibility of erroneous detection and the appropriateness is low. In this case, a low evaluation value is set. On the other hand, in a case where the calculated sum total of the amounts of increase is equal to or smaller than the threshold, it can be determined that a normal time-course change exists and the appropriateness is high. In this case, a high evaluation value is set. According to the foregoing method, appropriateness can be determined in consideration of an excessive enlargement of the crack based on erroneous detection and the like.

Note that a defect such as a crack is a characteristic that occurs in a part of an image. Therefore, there is a possibility that the same crack is detected at different positions in different images. In a case where there is such a subtle displacement of the position at which the defect is detected, there is a possibility that a difference in the defect is detected. For this reason, the difference may be calculated using a method that reduces the influence of the positional displacement by, for example, expanding the crack or causing the positions to be aligned. Furthermore, pieces of vector data indicating the defect may be converted into pieces of characteristic data that can be compared with each other. In this case, an evaluation value can be calculated based on a distance between the pieces of characteristic data.

The determination unit 205 determines the appropriateness of the time-course change or an evaluation value thereof in the above-described manner with respect to each of the plurality of recognition results A obtained in step S303. Then, the determination unit 205 selects a recognition result A from among the plurality of recognition results A based on such appropriatenesses or evaluation values. In an embodiment, the recognition result A selected by the determination unit 205 yields the highest appropriateness or the largest evaluation value among the plurality of recognition results A.

In the above-described embodiment, the plurality of sessions of recognition processing are executed with respect to one recognition target image. Incidentally, the input unit 201 may obtain a plurality of recognition target images. Here, the plurality of recognition target images can be images of the same object that were captured during the same period of time. Meanwhile, the plurality of recognition target images may be images that were captured under different capturing settings. In this case, it is possible to perform a search from the plurality of images. That is to say, the recognition unit 204 generates a plurality of recognition results by executing the recognition processing with respect to each of the recognition target images. Then, the determination unit 205 can select a recognition result from among the plurality of recognition results based on changes between the comparison target result and the recognition results, similarly to the above-described embodiment. Specifically, a recognition result indicating a time-course change with high appropriateness can be selected based on the above-described evaluation values. In such an embodiment, the plurality of sessions of recognition processing may be recognition processing on each of the recognition target images that uses the same model and parameter. Meanwhile, the recognition unit 204 may execute the plurality of sessions of recognition processing with respect to each of the recognition target images, similarly to the above-described embodiment. As described above, the plurality of sessions of recognition processing may differ from one another in one of a model used in the recognition processing, a parameter of the recognition processing, and a recognition target image to undergo the recognition processing. In this way, a search for one or more of the image, the model, and the parameter can be performed.

According to the present embodiment, a recognition result can be selected from among a plurality of recognition results obtained through recognition processing on a recognition target image so that the comparison target result and the selected recognition result indicates an appropriate time-course change. Therefore, even if there has been a change between images of an object due to different capturing conditions, it is possible to efficiently search for the content of the recognition processing for checking a time-course change with high accuracy, such as a model, a parameter, and an image to be processed. This can reduce a load on an inspection worker in adjusting the content of the recognition processing on a per-image basis. In addition, a recognition result that is suited for checking a time-course change in a recognition target can also be obtained efficiently.

### Second Embodiment

In the present embodiment, a comparison over time among a plurality of chronological recognition results is made. A recognition apparatus according to the second embodiment selects a recognition result from among a plurality of recognition results based on comparison among recognition results that were obtained from object images of three or more different time points. In the present embodiment, a recognition result is selected so that chronological recognition results indicate appropriate time-course changes as a whole.

The recognition apparatus according to the present embodiment can have the functional configuration shown in FIG. 2. The following describes the differences from the first embodiment. A description of the functions and processing that are the same as those of the first embodiment will be omitted.

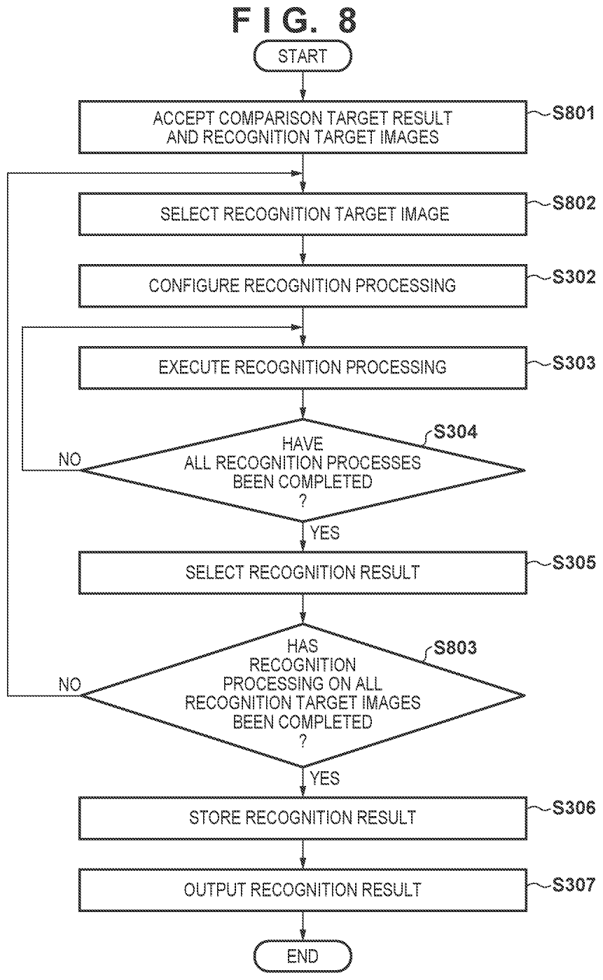

FIG. 8 is a flowchart showing a flow of recognition processing executed by the recognition apparatus according to the present embodiment. Processing that is the same as processing shown in FIG. 3 is given the same reference signs thereas.

In step S801, the input unit 201 accepts a plurality of recognition target images as inputs. In the present embodiment, these plurality of recognition target images are images of the same object that were captured at different time points. For example, the input unit 201 can obtain not only a recognition target image that is an image of an object of a first time point (a first image), but also a recognition target image that is an image of the same object of a third time point (a third image). Also, the input unit 201 accepts a comparison target result as an input, similarly to the first embodiment. That is to say, the input unit 201 can obtain a comparison target result that is a recognition result obtained through the recognition processing on an image of the same object of a second time point (a second image), which is different from the recognition target images. The present embodiment makes it possible to make a comparison over time among the recognition results that have been obtained through the recognition processing on these first image and third image, respectively, and the comparison target result. In the following example, the second time point precedes the first time point. Also, the first time point precedes the third time point. Note that the order of the first time point, the second time point, and the third time point is not limited in particular.

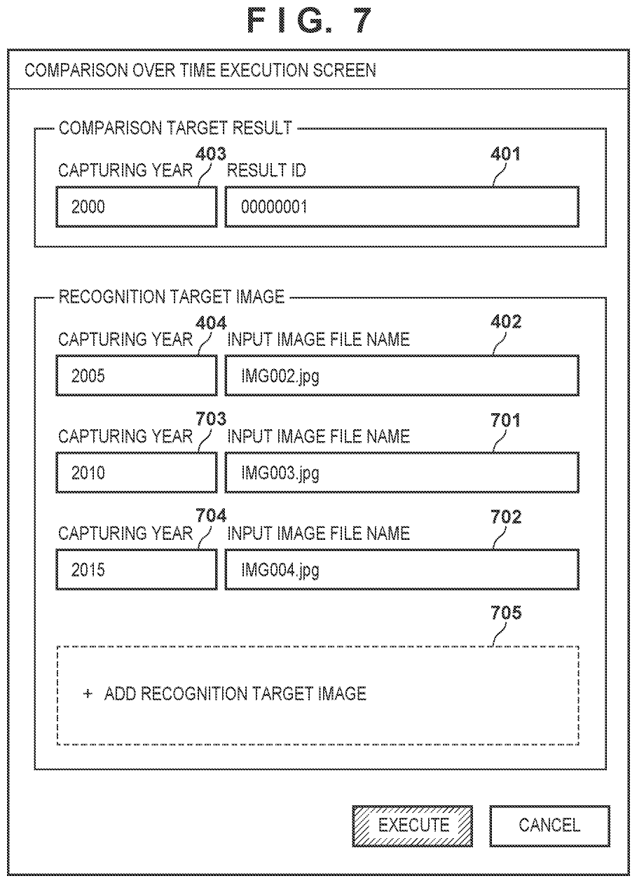

FIG. 7 shows an example of a UI displayed on a screen in the present embodiment. The UI shown in FIG. 7 includes an input area for designating a comparison target result, similarly to FIG. 4. Also, the UI shown in FIG. 7 includes an input area for designating a plurality of recognition target images. In the present example, similarly to FIG. 4, file names 402, 701, and 702 of images that are selected as recognition target images are designated. Furthermore, similarly to FIG. 4, capturing years 404, 703, and 704 of the recognition target images may be designated. In addition, when an input has been made with respect to an area 705, an input area for a file name and a capturing year of yet another recognition target image is displayed.

Similarly to the first embodiment, the image management unit 202 stores the plurality of recognition target images that have been designated by a user via the UI. In this way, the image management unit 202 manages the input plurality of recognition target images together with chronological information based on the input capturing years. Also, similarly to the first embodiment, the input unit 201 supplies the designated comparison target result to the determination unit 205.

In step S802, the image management unit 202 selects a recognition target image from among the plurality of recognition target images input in step S801. The capturing year of the recognition target image selected in step S802 is closest to the capturing year corresponding to the comparison target result among the capturing years of the recognition target images for which the recognition processing of step S304 has not been executed.

Steps S302 to S304 are executed in a manner similar to the first embodiment, thereby generating a plurality of recognition results B corresponding to the recognition target image selected in step S802. In step S305, the determination unit 205 selects a recognition result from among the plurality of recognition results generated in steps S302 to S304. Here, the determination unit 205 selects a recognition result B from among the plurality of recognition results B based on changes between the recognition results B and a recognition result A, similarly to the first embodiment.

The recognition result A is the comparison target result, or a recognition result that has already been selected in step S305. In the present example, the capturing year corresponding to the recognition result A is closest to the capturing year corresponding to the recognition result B among the capturing years corresponding to the comparison target result and the recognition result that has already been selected in step S305. Note that a capturing year corresponding to a recognition result denotes a capturing year of a recognition target image that has been used to generate the recognition result.

For example, in a case where the recognition result B is a recognition result corresponding to the third image (a third recognition result), the recognition result A may be a recognition result corresponding to the first image (a first recognition result). In step S304, the recognition unit 204 executes a plurality of sessions of recognition processing for recognizing a recognition target with respect to the third image, thereby generating a plurality of third recognition results that respectively correspond to the plurality of sessions of recognition processing. Here, the determination unit 205 can select a recognition result from among the plurality of third recognition results based on changes between a recognition result selected from among a plurality of first recognition results and the third recognition results.

Specifically, similarly to the first embodiment, the determination unit 205 can select a recognition result B based on the appropriateness of a time-course change, or based on evaluation values indicating the appropriateness. For example, the determination unit 205 can select a recognition result B that yields the largest evaluation value among the plurality of recognition results B.

In step S803, the image management unit 202 determines whether the recognition processing has been completed with respect to every recognition target image. In a case where the recognition processing has not been completed with respect to every recognition target image, processing returns to step S802, and the next recognition target image is selected. In a case where the recognition processing has been completed with respect to every recognition target image, processing proceeds to step S306. According to the present example, a search for a recognition result that yields high appropriateness is performed with respect to each recognition target image, in the order from the higher closeness to the lower closeness between the capturing years of the recognition target images and the capturing year corresponding to the comparison target result.

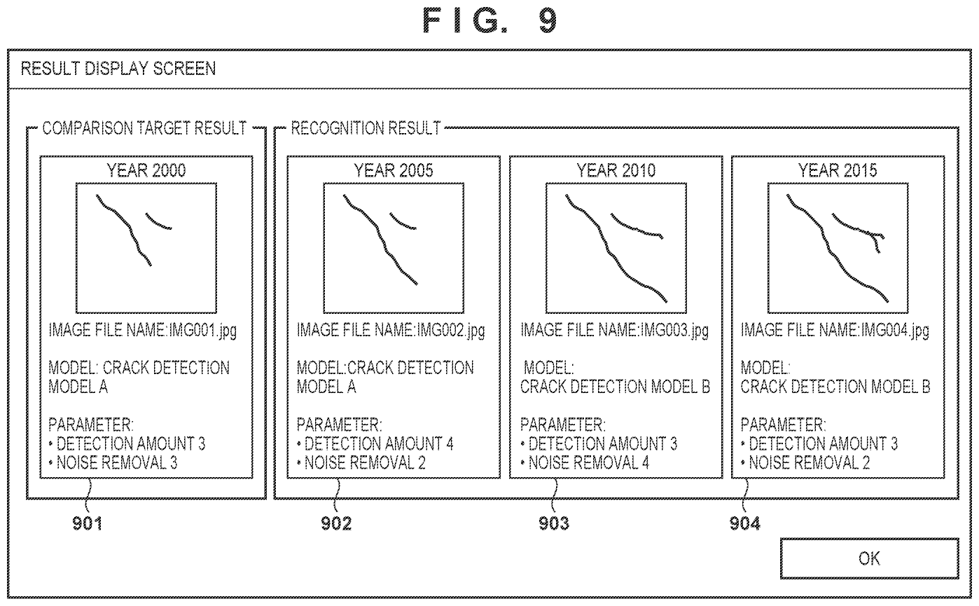

Processing of steps S306 and S307 is executed in a manner similar to the first embodiment. In the case of the present embodiment, in step S307, the output unit 207 can output each of the recognition results selected in step S305. FIG. 9 shows an example of a result display screen according to the present embodiment. FIG. 9 shows a comparison target result 901 input in step S801, and recognition results 902 to 904 selected in step S305. The comparison target result 901 and the recognition results 902 to 904 are arranged in accordance with the capturing years that have been set.

According to the present embodiment, a recognition result is selected from among a plurality of recognition results obtained through the recognition processing on a recognition target image in connection with each of a plurality of time points, so that chronological recognition results indicate appropriate time-course changes as a whole. According to the present embodiment, a recognition result that is suited for checking time-course changes in a recognition target at three or more time points can be obtained efficiently.

### Modification Example

The relationship between the capturing timing of an image that has been used to generate a comparison target result and the respective capturing timings of a plurality of recognition target images is not limited in particular. For example, the capturing year corresponding to the comparison target result may exist at any point in the chronology of the target of conformation of a time-course change. Furthermore, the capturing year corresponding to the comparison target result may be restricted so that it precedes or succeeds the respective capturing years of the plurality of recognition target images.

Also, in the above-described embodiment, the determination unit 205 compares a plurality of recognition results A with a recognition result B and selects a recognition result A that has yielded the largest evaluation value in step S305. In this way, the determination unit 205 can calculate evaluation values based on comparison between the recognition results A and the recognition result B of time points that are adjacent to each other in the chronology, and select a recognition result A based on the evaluation values. Meanwhile, the determination unit 205 can select recognition results of the respective time points based on the appropriateness of a time-course change indicated by all of the recognition results included in the chronology. For example, the recognition results of the respective time points may be selected so that an evaluation value corresponding to a pair of recognition results of time points that are adjacent to each other in the chronology is larger in the entire chronology. As described above, the determination unit 205 can select a recognition result from among a plurality of first recognition results based on changes between the comparison target result and the plurality of first recognition results. Meanwhile, in the present modification example, the determination unit 205 can select a recognition result from among the plurality of first recognition results further based on changes between the plurality of first recognition results and a recognition result selected from among a plurality of third recognition results.

In this case, step S305 may be skipped; after step S803, the determination unit 205 can calculate an evaluation value per combination of recognition results for each time point. For each of the plurality of recognition target images, each combination is composed of one of the plurality of recognition results obtained in step S303 and the comparison target result. In this case, for example, with respect to one combination of recognition results, the determination unit 205 can total the evaluation values corresponding to pairs of recognition results of time points that are adjacent to each other in the chronology. Then, the determination unit 205 can select, from among the plurality of combinations of recognition results, a combination of recognition results for which the largest evaluation value has been obtained as the total. Note that in such a configuration, it is not essential for a combination to include the comparison target result.

### Third Embodiment

In the present embodiment, the content of recognition processing on a recognition target image is set in accordance with the content of recognition processing for obtaining a comparison target result. Furthermore, the content of recognition processing can be set based on comparison between metadata of an image that was used to obtain a comparison target result and metadata of a recognition target image.

A recognition apparatus according to the present embodiment can have the functional configuration shown in FIG. 2. Also, recognition processing according to the present embodiment can be executed in accordance with the flowchart shown in FIG. 3. The following describes the differences from the first embodiment. A description of the functions and processing that are the same as those of the first embodiment will be omitted. Note that it is possible to make a comparison over time among a plurality of recognition results, similarly to the second embodiment.

In step S301, the input unit 201 accepts a recognition target image and a comparison target result as inputs. At this time, the input unit 201 further obtains metadata of the recognition target image. The input unit 201 can obtain Exchangeable image file format (Exif) data, for example. Exif is used as an image file format for photographs obtained through capturing performed by a digital camera. The Exif data includes not only image data, but also metadata related to an image (e.g., a capturing date/time, a type of a digital camera, a shutter speed, an f-number, and the like), as Exif information. The input unit 201 can extract the metadata of the image that is included in the Exif data in the above-described manner, and store the metadata into the image management unit 202. Note that the metadata of the recognition target image may be input by a worker.

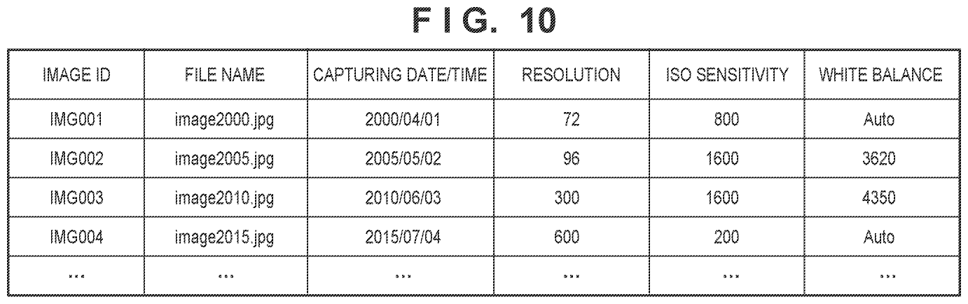

FIG. 10 shows examples of the metadata of the recognition target image stored in the image management unit 202. As shown in FIG. 10, the image management unit 202 stores image information such as a file name, a capturing date/time, a resolution, an ISO film speed, and white balance in association with an image ID. The image information stored in the image management unit 202 may include other information such as a type of the digital camera and a shutter speed. Furthermore, it is assumed that metadata of the image that was used to generate the comparison target result is similarly obtained and stored into the image management unit 202. In the present embodiment, the metadata that has been stored into the image management unit 202 in the above-described manner is used by the search unit 203 to determine search ranges.

In step S302, the search unit 203 configures settings for a plurality of sessions of recognition processing. In the present embodiment, the search unit 203 sets the content of the recognition processing in accordance with the content of the recognition processing that was executed for a second image of a second time point to obtain the comparison target result.

In the present embodiment, the search unit 203 determines search ranges for setting the plurality of sessions of recognition processing. For example, the search unit 203 can determine search ranges for a model and a parameter. Then, the search unit 203 configures settings for the plurality of sessions of recognition processing in accordance with the search ranges, similarly to the first embodiment.

Here, the search unit 203 can set the search ranges in accordance with the content of the recognition processing that was executed for an image of an object to obtain the comparison target result. More specifically, the search unit 203 can set the search ranges for the model and parameter in accordance with the model and parameter that were used in the recognition processing for obtaining the comparison target result. As one example, assume that “detection amount”=3 and “noise removal”=4 have been set as a parameter in the recognition processing for obtaining the comparison target result. In this case, for example, a search range for “detection amount” can be set at 3±1, and a search range for “noise removal” can be set at 4±1. Similarly, a model group that yields a recognition result similar to the model used in the recognition processing for obtaining the comparison target result can be set as the search range for the model.

Meanwhile, the content of the recognition processing can be set based on comparison between the metadata of the image that was used to obtain the comparison target result and the metadata of the recognition target image. At this time, the search unit 203 compares the metadata of the recognition target image stored in the image management unit 202 with the metadata of the image that was used to obtain the comparison target result. In the present embodiment, the search unit 203 determines search ranges for setting the plurality of sessions of recognition processing based on such comparison between the pieces of metadata. Specifically, the search unit 203 can estimate a model and a parameter suited for obtainment of a recognition result indicating an appropriate time-course change based on a difference between these pieces of metadata. The following examples are possible as a specific determination method. Then, the search unit 203 determines the search ranges based on the estimated model and parameter.

(Example 1) In this example, an image resolution is used as the pieces of metadata to be compared. Also, a suitable “detection width” parameter is estimated. Here, for example, in a case where the recognition target image has a higher resolution than the image that was used to generate the comparison target result, fine cracks are sharply shown in the recognition target image. Therefore, there is a high possibility that more cracks are detected from the recognition target image than from the comparison target result. In view of this, a value larger than the “detection width” parameter used to obtain the comparison target result is estimated as a parameter suited for the recognition target image. In this case, a threshold related to the width of cracks detected from the recognition target image becomes large. In this way, by comparing the resolutions, cracks that are equal in amount to cracks in the comparison target result are expected to be detected from the recognition target image regardless of the resolutions.

(Example 2) In this example, an ISO film speed is used as the pieces of metadata to be compared. Also, a suitable “noise removal” parameter is estimated. Here, in a case where the ISO film speed of the recognition target image is higher than the ISO film speed of the image that was used to generate the comparison target result, a larger amount of noise appears in the image. Therefore, it is considered that more cracks are erroneously detected from the recognition target image than from the comparison target result. In view of this, a value larger than the “noise removal” parameter used to obtain the comparison target result is estimated as a parameter suited for the recognition target image. In this way, by comparing the ISO film speeds, cracks that are equal in amount to cracks in the comparison target result are expected to be detected from the recognition target image regardless of the ISO film speeds.

(Example 3) In this example, white balance is used as the pieces of metadata to be compared. Also, a model corresponding to the brightness of white balance is used for the recognition processing. Here, assume that the white balance set for the recognition target image is brighter than the white balance set for the image that was used to generate the comparison target result. In this case, a model corresponding to brighter white balance than the model used to obtain the comparison target result is estimated as a model suited for the recognition target image.

As described above, the search unit 203 compares the pieces of metadata of the image that was used to generate the comparison target result and the recognition target image. Then, in accordance with the difference between the pieces of metadata, the search unit 203 adjusts the model or parameter that has been used to obtain the comparison target result. In this way, the search unit 203 can estimate a model or a parameter suited for the recognition processing on the recognition target image. The pieces of metadata to be compared are not limited to the ones described above. For example, the pieces of metadata to be compared may be a capturing date/time, a color space, whether a flash is to be used, a focal length, or the like. Furthermore, a plurality of types of metadata may be used in combination. In an embodiment, pieces of metadata indicating a capturing condition (e.g., a shutter speed, an f-number, an ISO film speed, white balance, or capturing time) are compared. In another embodiment, pieces of metadata indicating a configuration of a capturing apparatus (e.g., a model of the apparatus or a type of an optical system) are compared. In still another embodiment, pieces of metadata indicating an image attribute (e.g., a resolution or a color space) are compared.

Then, the search unit 203 determines a search range for a model or a parameter based on the model or the parameter that has been estimated in the above-described manner. For example, the search unit 203 can set a search range centered at the estimated model or parameter. Note that the search unit 203 can estimate at least one of the suitable model and parameter. Furthermore, the search unit 203 can set a search range for at least one of a model and a parameter.

Processing of step S303 onward can be executed in a manner similar to the first embodiment. According to the present embodiment, a recognition result indicating an appropriate time-course change can be efficiently obtained from a recognition target image either in accordance with the content of recognition processing for obtaining a comparison target result, or based on comparison between pieces of metadata.

In the above-described embodiment, the search unit 203 determines search ranges for setting the plurality of sessions of recognition processing. Note that instead of the search unit 203 determining the search ranges, the recognition unit 204 may execute recognition processing that conforms with the content set by the search unit 203 with respect to the recognition target image. For example, the recognition unit 204 can execute the recognition processing using the model and parameter which have been estimated by the search unit 203 and which are suited for obtainment of a recognition result indicating an appropriate time-course change. In this case, the recognition unit 204 need not generate a plurality of recognition results that respectively correspond to the plurality of sessions of recognition processing. The recognition unit 204 may generate only one recognition result by executing one session of recognition processing with respect to one recognition target image.

That is to say, the search unit 203 can set the content of recognition processing that is executed with respect to the recognition target image to recognize a recognition target. Here, the search unit 203 sets the content of recognition processing on an image of an object of a first time point in accordance with the content of recognition processing that was executed with respect to an image of the object of a second time point to obtain the comparison target result. Also, the recognition unit 204 can generate a recognition result by applying the recognition processing that conforms with the set content to the recognition target image.

### Fourth Embodiment

In the present embodiment, a recognition result corresponding to an image that has metadata similar to a recognition target image is selected as a comparison target result. A recognition apparatus according to the present embodiment can have the functional configuration shown in FIG. 2. Also, recognition processing according to the present embodiment can be executed in accordance with the flowchart shown in FIG. 3. The following describes the differences from the first embodiment. A description of the functions and processing that are the same as those of the first embodiment will be omitted. Note that it is possible to make a comparison over time among a plurality of recognition results, similarly to the second embodiment. In this case, a comparison target result can be selected based on one of the plurality of recognition target images.

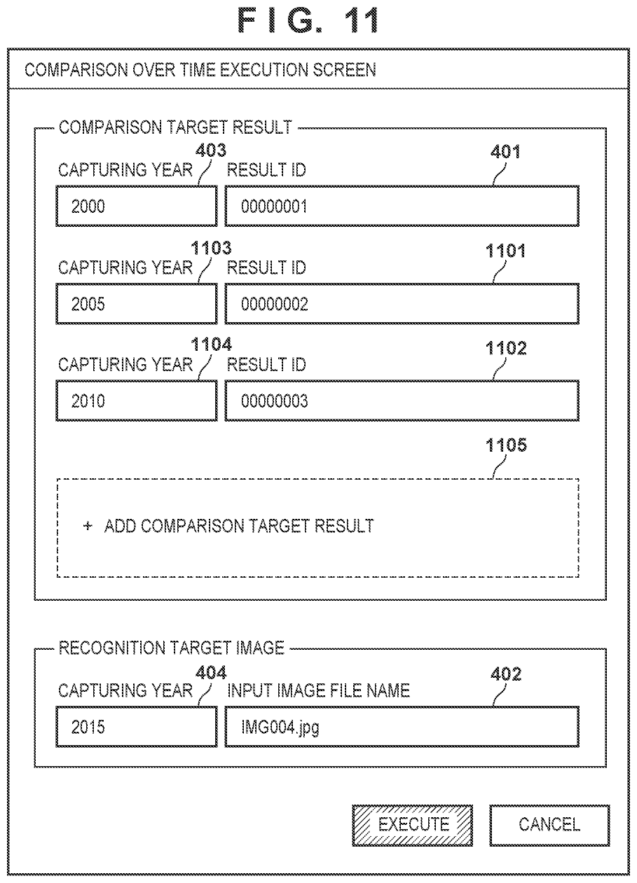

In step S301, the input unit 201 accepts a recognition target image and comparison target results as inputs. In the present embodiment, the input unit 201 accepts a plurality of comparison target results as inputs. FIG. 11 shows an example of a UI displayed on a screen in the present embodiment. The UI shown in FIG. 11 includes an input area for designating a recognition target image, similarly to FIG. 4. Also, the UI shown in FIG. 11 includes an input area for designating a plurality of comparison target results. In the present example, result IDs 401, 1101, and 1102 indicating the comparison target results are designated. Furthermore, similarly to FIG. 4, capturing years 404, 1103, and 1104 of the images that were used to generate the comparison target results may be designated. In addition, when an input has been made with respect to an area 1105, an input area for a result ID and a capturing year of yet another comparison target result is displayed. The input unit 201 stores the input recognition target image into the image management unit 202. In the present embodiment, the comparison target results are stored in the result management unit 206 in advance. Also, the images that were used to generate the comparison target results are stored in the image management unit 202 in advance.

In step S302, the search unit 203 selects an image from among a plurality of images of an object as a second image of the object at a second time point. The search unit 203 selects the second image from among the plurality of images of the object that were used to generate a part of the plurality of comparison target results designated in step S301. Here, the second image is set based on comparison between respective pieces of metadata of the plurality of images of the object and metadata of the recognition target image.

The following describes a method in which the search unit 203 selects the second image from among the plurality of images. First, with respect to each of the plurality of comparison target results designated in step S301, the search unit 203 refers to metadata of the image that was used to generate the comparison target result. For example, based on a result ID designated in step S301, the search unit 203 specifies an image ID of an image that was used to generate the comparison target result which is managed in the result management unit 206 and which corresponds to this result ID. Then, the search unit 203 obtains metadata of the image which is indicated by the specified image ID and which is stored in the image management unit 202.

Then, the search unit 203 determines similarities between the metadata of the recognition target image input in step S301 and the pieces of metadata of the plurality of images that were respectively used to generate the comparison target results, which have been obtained in the aforementioned manner. Then, based on the determined similarities, the search unit 203 selects an image that is most similar to the metadata of the recognition target image among these plurality of images as the second image. Furthermore, with reference to the result management unit 206, the search unit 203 can also obtain the content and the result of recognition processing on the second image that has metadata similar to the recognition target image.

One example of a method of determining similarities among pieces of metadata is a method of counting the number of matching items among the items included in metadata. Another example is a method of setting a score for each item of metadata in accordance with a predetermined standard, and obtaining a sum total of differences between scores for each item. Note that in determining similarities between pieces of metadata, all items may be compared, or a part of items may be compared.

In step S302, the search unit 203 can further set the content of the recognition processing on the recognition target image in accordance with the content of the recognition processing on the selected second image, similarly to the third embodiment. For example, the search unit 203 can determine a search range (e.g., a search range for a model or a parameter) for setting a plurality of sessions of recognition processing, similarly to the third embodiment. At this time, the search unit 203 may determine the search range based on comparison between the metadata of the image that was used to obtain the selected comparison target result and the metadata of the recognition target image. Note that the search unit 203 may set the content of the recognition processing on the recognition target image in a manner similar to the first embodiment. Also, only one session of recognition processing may be executed with respect to the recognition target image.

Processing of step S303 onward can be executed in a manner similar to the first embodiment. Note that the output unit 207 may present the image selected by the search unit 203 in step S302 or the comparison target result obtained through the recognition processing on this image to a user. With this configuration, the user can efficiently check the recognition result obtained from the recognition target image by comparing the same with the presented image or comparison target result.

According to the present embodiment, a recognition result corresponding to an image that has metadata similar to a recognition target image is selected as a comparison target result. There is a high possibility that the second image that has metadata similar to the recognition target image has been obtained under a capturing condition similar to that of the recognition target image. Therefore, the comparison target result obtained from such a second image and the recognition result corresponding to the recognition target image are expected to be uniform; it is thus expected that a recognition result indicating an appropriate time-course change be obtained. Especially, in an embodiment, the content of the recognition processing is set in accordance with the content of the recognition processing corresponding to the image that has metadata similar to the recognition target image. In this way, a recognition result indicating an appropriate time-course change can be obtained more efficiently.

Note that in the present embodiment, it is not essential for the input unit 201 to accept the comparison target results as inputs. For example, the second image that has metadata similar to the recognition target image may be searched for from among the images of the same object that have already been stored in the image management unit 202.

In each of the above-described embodiments, the output unit 207 displays recognition results that respectively correspond to a comparison target result and one or more recognition target images in a chronological manner. Meanwhile, in order to obtain a more appropriate recognition result, the user may change a model, a parameter, or an image and re-execute the recognition processing with respect to a part of the recognition target images. For this reason, the output unit 207 can store recognition results in the result management unit 206. Furthermore, the result management unit 206 can manage recognition results so that they can be displayed or edited even after the recognition processing has ended.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-069517, filed Apr. 20, 2023, which is hereby incorporated by reference herein in its entirety.

What is claimed is:

1. A recognition apparatus comprising one or more memories storing instructions and one or more processors that execute the instructions to:
generate, through a plurality of sessions of recognition processing on an image of an object of a first time point, a plurality of first recognition results that respectively correspond to the plurality of sessions of recognition processing, the plurality of sessions of recognition processing being for recognizing a recognition target;
select a recognition result from among the plurality of first recognition results based on respective changes between a second recognition result and the respective first recognition results, the second recognition result having been obtained through recognition processing on an image of the object of a second time point; and
output the selected recognition result.

2. The recognition apparatus according to claim 1, wherein the one or more processors execute the instructions to select the recognition result based on appropriateness of a time-course change indicated by the first recognition result and the second recognition result.

3. The recognition apparatus according to claim 1, wherein
the second time point succeeds the first time point, and
the one or more processors execute the instructions to determine a change from the first recognition result to the second recognition result, and select the recognition result based on matching between the determined change and a standard.

4. The recognition apparatus according to claim 1, wherein the one or more processors execute the instructions to determine a change between a feature related to the recognition target indicated by the first recognition result and a feature related to the recognition target indicated by the second recognition result, and select the recognition result based on matching between the determined change and a standard.

5. The recognition apparatus according to claim 1, wherein the one or more processors execute the instructions to generate the plurality of first recognition results by applying each of the plurality of sessions of recognition processing that differ from one another to the image of the object of the first time point.

6. The recognition apparatus according to claim 1, wherein
the plurality of sessions of recognition processing differ from one another in at least one of a model used in the recognition processing, a parameter of the recognition processing, and the image of the object of the first time point to undergo the recognition processing.

7. The recognition apparatus according to claim 1, wherein the one or more processors execute the instructions to:
generate a plurality of third recognition results through a plurality of sessions of recognition processing on an image of the object of a third time point, the plurality of third recognition results respectively corresponding to the plurality of sessions of recognition processing, the plurality of sessions of recognition processing being for recognizing the recognition target; and
select a recognition result from among the plurality of third recognition results based on respective changes between the recognition result selected from among the plurality of first recognition results and the respective third recognition results.

8. The recognition apparatus according to claim 7, wherein the one or more processors execute the instructions to select the recognition result from among the plurality of first recognition results based on both of a change between the second recognition result and the recognition result selected from among the plurality of first recognition results and a change between the recognition result selected from among the plurality of first recognition results and the recognition result selected from among the plurality of third recognition results.

9. The recognition apparatus according to claim 7, wherein
the second time point precedes the first time point, and the first time point precedes the third time point.

10. The recognition apparatus according to claim 1, wherein the one or more processors execute the instructions to set content of the recognition processing on the image of the object of the first time point in accordance with content of the recognition processing that has been executed on the image of the object of the second time point to obtain the second recognition result.

11. The recognition apparatus according to claim 10, wherein the one or more processors execute the instructions to set the content of the recognition processing on the image of the object of the first time point further based on comparison between metadata of the image of the object of the first time point and metadata of the image of the object of the second time point.

12. The recognition apparatus according to claim 10, wherein the one or more processors execute the instructions to set a search range for setting the plurality of sessions of recognition processing in accordance with the content of the recognition processing that has been executed on the image of the object of the second time point to obtain the second recognition result.

13. The recognition apparatus according to claim 10, wherein the one or more processors execute the instructions to select an image from among a plurality of images of the object as the image of the object of the second time point based on comparison between respective pieces of metadata of the plurality of images of the object and metadata of the image of the object of the first time point.

14. The recognition apparatus according to claim 1, wherein
the object is a structure.

15. The recognition apparatus according to claim 14, wherein
the recognition target is a defect that has occurred in the structure.

16. The recognition apparatus according to claim 1, wherein the one or more processors execute the instructions to manage a plurality of images of the object of different time points.

17. The recognition apparatus according to claim 1, wherein the one or more processors execute the instructions to output a screen that shows the plurality of first recognition results and the second recognition result in a chronological manner.

18. A recognition apparatus comprising one or more memories storing instructions and one or more processors that execute the instructions to:
set content of recognition processing, for recognizing a recognition target, on an image of an object of a first time point based on content of recognition processing that has been executed on an image of the object of a second time point to obtain a second recognition result, and on comparison between metadata of the image of the object of the first time point and metadata of the image of the object of the second time point;
generate a first recognition result by applying the recognition processing that conforms with the set content on the image of the object of the first time point; and
output the first recognition result and the second recognition result.

19. A recognition method comprising:
generating, through a plurality of sessions of recognition processing on an image of an object of a first time point, a plurality of first recognition results that respectively correspond to the plurality of sessions of recognition processing, the plurality of sessions of recognition processing being for recognizing a recognition target;
selecting a recognition result from among the plurality of first recognition results based on respective changes between a second recognition result and the respective first recognition results, the second recognition result having been obtained through recognition processing on an image of the object of a second time point; and
outputting the selected recognition result.

20. A non-transitory computer-readable medium storing a program executable by a computer to perform a method comprising:
generating, through a plurality of sessions of recognition processing on an image of an object of a first time point, a plurality of first recognition results that respectively correspond to the plurality of sessions of recognition processing, the plurality of sessions of recognition processing being for recognizing a recognition target;
selecting a recognition result from among the plurality of first recognition results based on respective changes between a second recognition result and the respective first recognition results, the second recognition result having been obtained through recognition processing on an image of the object of a second time point; and
outputting the selected recognition result.
